(19) United States
(12) Patent Application Publication
(10) Pub. No.: US 2001/0036305 A1
(43) Pub. Date: Nov. 1, 2001

(54) Detecting and compensating defective pixels in image sensor on real time basis

(76) Inventor: Sung-Chun Jun, Ichon-shi (KR)

Correspondence Address: PILLSBURY WINTHROP LLP, 1600 TYSONS BOULEVARD, MCLEAN, VA, 22102, US

(21) Appl. No.: 09/750,221

(22) Filed: Dec. 29, 2000

(30) Foreign Application Priority Data
Dec. 30, 1999 (KR) 1999-65826

(51) Int. Cl. G06K 9/00

(52) U.S. Cl. 382/149

(57) ABSTRACT

An apparatus for detecting and compensating defective pixels in a real time by using a two-dimension space filter and characteristics of image data simplifies test processes for an image sensor and enhances yield of the image sensor chip. The apparatus includes: a defect pixel detection block for detecting and determining a defective pixel based on a check condition, the condition representing that image data of the defective pixel has a value larger than a first coefficient of the maximum image data of adjacent normal pixels or a value smaller than a second coefficient of the minimum image data of that; and a defect pixel compensation block for compensating the image data of the defective pixel and outputting compensated image data, in response to the image data of a check target pixel, the maximum image data of the adjacent normal pixels, the minimum image data of the adjacent normal pixels, a defective pixel determination signal representing that the target pixel is defective, and a minimum or maximum range violation signals representing that the image data of the defective pixel violates the maximum or minimum ranges in the check condition, which are provided thereto from the defective pixel detection block.

### BACKGROUND

1. Field of the Invention

The claimed inventions relate in general to image sensors. More specifically, the claimed inventions relate in part to an apparatus for detecting defective pixels during fabrication of an image sensor on a real time basis, and notifying a manufacturer of the position of detected defective pixels to thereby allow the defective pixels to be compensated.

2. General Background and Related Art

In general, an image sensor captures an image by using the response characteristics of a semiconductor device to incident light. An object optically imaged on an image sensor has its brightness and wavelength converted electrical signals representing brightness and wavelength on a pixel by pixel basis. A particular brightness and wavelength cause the image sensor to produce a particular electrical signals having defined values characterizing the image qualities.

The image sensor has a pixel array including tens of thousands to hundreds of thousands of unit pixels. Several thousand converting units convert analog voltages provided by the pixels into a digital signal representations of those voltages. Tens of thousands to hundreds of thousands of storage units store the converted digital voltage signals. Due to the considerable number of pixels and the various converting units, it is easy for a pixel or converter unit to in a manufactured image sensor to be bad, thereby causing erroneous imaging.

Image sensors are graded based on the number of defective pixels. A high quality image sensor has fewer defective pixels and therefore more pixels available for imaging work. The smaller the number of defective pixels, the higher the grade of the image sensor. On a display screen, defective pixels in an image sensor may be indicated by a fine spot or line. If one or more defective pixels cause an image sensor chip to be considered to be a defective chip, the manufacturing process has a degraded yield.

One known way of dealing with the defective pixel problem is to map the defective pixels, so that they are not relied upon in some industrial application. The image sensors are not discarded because they have some bad pixels. Rather, the image sensor is used in a context allowing the remaining good pixels to be utilized. The location of defective pixels is determined and stored in a non-active memory such as EEPROM. During the implementation of an imaging system, the non-active memory having the critical data is utilized to avoid reliance on bad pixels.

Referring to FIG. 1 (Prior Art), there is shown a block diagram of the prior art apparatus for detecting and compensating a defective pixel. The prior art apparatus comprises an image sensor chip 100 and a memory 120 mounted outside of the image sensor chip 100 for storing position information of a defective pixel detected during the test processes. The image sensor chip 100 includes a pixel array 101, an inner memory 102 for storing therein the position information provided thereto from the external memory 120, and a compensation block 103 for compensating image data of the defective pixel fed thereto from the pixel array 101 in response to the position information form the inner memory 102, and outputting compensated image data for the defective pixel.

Position information downloaded from the external memory 120 is stored in the inner memory 102 and compensates the image data of the defective pixel with reference to image data of normal pixels adjacent to the defective pixel, thereby preventing a screen degradation of the imaging system due to the defective pixel and allowing the image sensor chip with the defective pixel to be operated As a result, the yield degradation due to the defective pixel has been somewhat prevented.

This known arrangement has an operational drawback. During the mass-production test process, the test process of extracting the position information of the defective pixel is complex to result in a prolonged processing time for the test. In addition, since an image sensor production company has to offer an additional non-active memory having the position information of the defective pixel to a corresponding system industrial, the prior art has a shortcoming that it increases the unit cost of production.

### SUMMARY

The inventions claimed herein feature, at least in part, an apparatus which is capable of detecting and compensating for defective pixels on a real time basis. The apparatus uses a two-dimension space filter and characteristics of image data, without an additional non-active memory, thereby simplifying test processes for the image sensor and enhancing yield of the image sensor chip.

One exemplary embodiment features an apparatus, in a image sensor including a pixel array in which a multiplicity of unit pixels are aligned, each of which outputs digital image data corresponding to a characteristic of incident light, such as, for example, intensity. There is provided an arrangement for detecting and compensating for defective pixels among the multiplicity of unit pixels. This arrangement includes a defect pixel detection block for detecting and determining whether a target pixel is defective based on a check condition. One such exemplary condition is that value of image data of the defective pixel is larger than a first coefficient corresponding to the maximum value of image data of adjacent normal pixels or a value smaller than a second coefficient corresponding to the minimum value of image data of adjacent normal pixels. A defect pixel compensation block compensates the image data of the defective pixel and outputs compensated image data. Compensation is responsive to the image data of a check target pixel, the maximum value of image data of a adjacent normal pixels, the minimum value of image data of adjacent normal pixels, a defective pixel determination signal representing that the target pixel is defective, and a minimum or maximum range violation signal representing that the image data of the defective pixel violates predetermined maximum or minimum ranges in the check condition, which are provided thereto from the defective pixel detection block.

### BRIEF DESCRIPTION OF THE DRAWINGS

Exemplary embodiments illustrating the principles of the claimed inventions will be described in detail with reference to the accompanying drawings, in which:

FIG. 1 (Prior Art) is a block diagram illustrating a conventional defective pixel detection and compensation process:

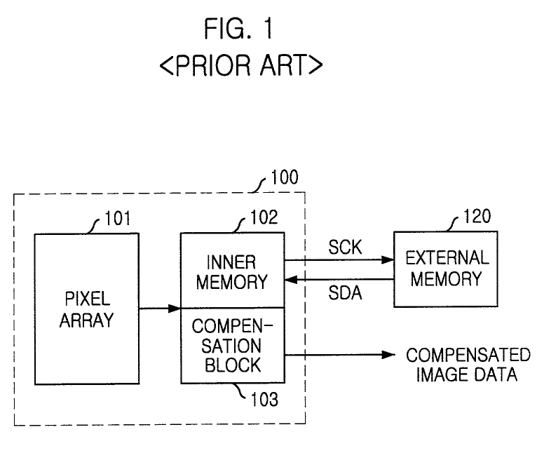

FIG. 2 is a schematic block diagram of an apparatus for detecting defective pixels and compensating the same, in accordance with a preferred embodiment of the present invention;

FIG. 3 is a detailed block diagram of the defective pixel detection block in accordance with a preferred embodiment of the present invention; and

FIG. 4 is a detailed block diagram of the defective pixel compensation block in accordance with the preferred embodiment of the present invention.

### DETAILED DESCRIPTION

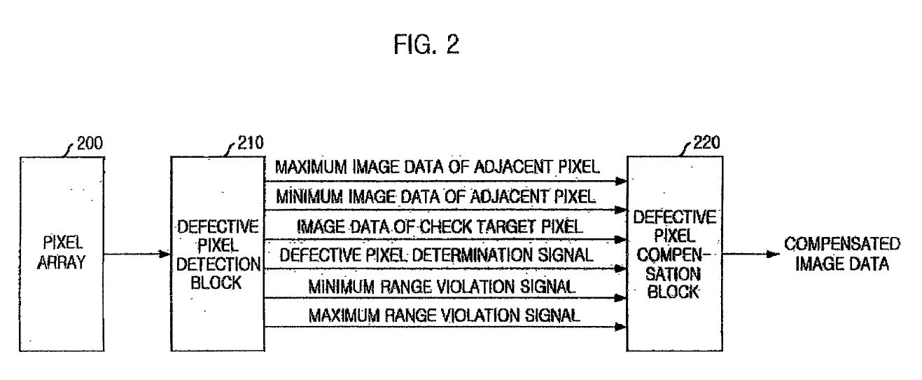

FIG. 2 is a schematic block diagram of an apparatus for detecting defective pixels and compensating the same, in accordance with a preferred embodiment of the present invention. A pixel array 200 has a multiplicity of unit pixels that are aligned according to a predetermined arrangement. Each pixel outputs digital image data DATA corresponding to one or more characteristics of light incident thereon, such as for example, intensity, wavelength, etc. A defective pixel detection block 210, in response to the DATA provided thereto from the pixel array 200, detects and determines defective pixels on a real time basis based on a check condition according to the characteristics of the image data. A defective pixel compensation block 220 compensates the image data of each defective pixel and outputs compensated image data. Defective pixel compensation block 220 responds to 1) image data of a check target pixel, 2) a defective pixel determination signal representing that the target pixel is defective and 3) range violation signals representing that the image data of the defective pixel violates the check condition provided thereto from the defective pixel detection block 210.

The defective pixel detection block 210 checks to determine whether a value of the image data of the check target pixel satisfies a predetermined condition. If the checked result is negative, the defective pixel detection block 210 determines that the corresponding pixel is defective and outputs the defective pixel determination signal. One such predetermined check condition that can be used by defective pixel detection block 210 is based on a characteristic that most defective pixels have a value of 1.1 times or larger as than the maximum value of image data of a adjacent normal pixels or a value of 0.9 times or smaller than the minimum value of image data of adjacent normal pixels. Simultaneously, the defective pixel detection block 210 outputs a maximum range violation signal and a minimum range violation signal representing that the image data of the defective pixel violates a range of the maximum value, i.e., the image data has a value of 1.1 times or larger than the maximum value of image data of adjacent normal pixels, and the image data of the defective pixel violates a range of the minimum value, i.e., the image data has a value of 0.9 times or smaller than the minimum value of image data of adjacent normal pixels.

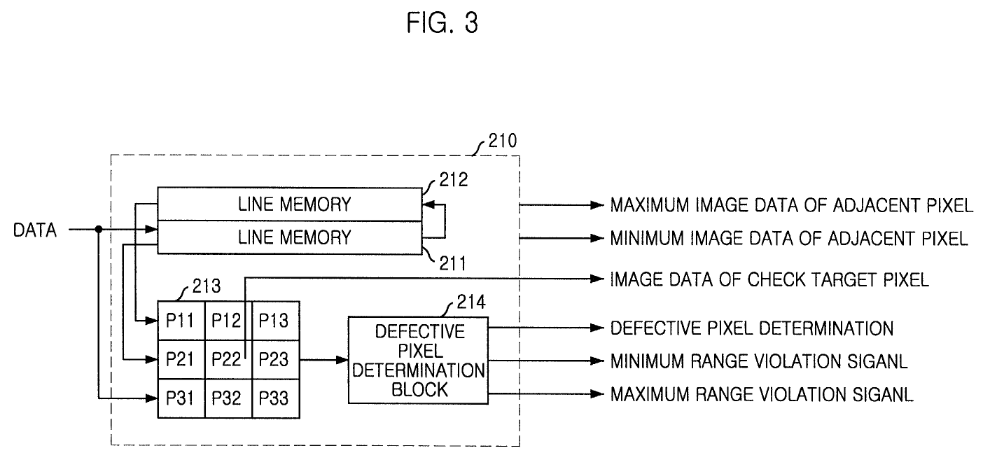

FIG. 3 is a detailed block diagram of the defective pixel detection block 210 in accordance with a preferred embodiment of the present invention. The defective pixel detection block 210 includes a first line memory 211 for storing digital image data DATA provided thereto from the unit pixel on a line-by-line basis. A second line memory 212 receives the digital image data stored in the first line memory 211 and stores the same therein. A 3×3 two-dimension space filter 213 receives the image data provided thereto from the second line memory 212, the image data provided thereto from the first line memory 211 and the image data provided thereto from the unit pixel, and stores each of the image data in a first set of lines P11, P12 and P13, a second set of lines P21, P22 and P23, and a third set of lines P31, P32 and P33, respectively. A defective pixel determination block 214 receives the image data provided thereto from the space filter 213 and determines whether or not a check target pixel, i.e., P22, is defective based on the condition mentioned above, and outputs the defective pixel determination signal, the minimum range violation signal and the maximum range violation signal according to corresponding results.

The defective pixel detection block 210 provides a maximum and minimum image data among the image data stored in the space filter 213 to the defective pixel compensation block 220 that compensates image data of the defective pixel.

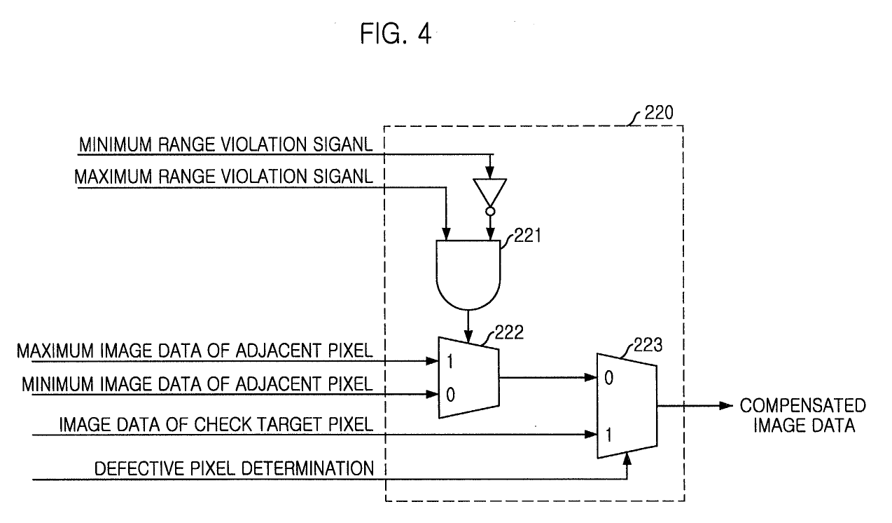

FIG. 4 is a detailed block diagram of the defective pixel compensation block 220 in accordance with the preferred embodiment of the present invention. The defective pixel compensation block 220 includes an AND gate 221 for combining the minimum range violation signal and the maximum range violation signal provided thereto from the defective pixel detection block 210. A multiplexer 222 selectively outputs the minimum image data or the maximum image data of the adjacent normal pixels, in response to output from the AND gate 221. A multiplexer 223 selects one of the output signal from the multiplexer 222 and the image data of the check target pixel, responsive to the defective pixel determination signal from the defective pixel determination block 214 and outputs the same as the compensated image data.

In the defective pixel compensation block 220, if the image data of the target pixel P22 has a value of 0.9 times or smaller than the minimum value of the adjacent normal pixels and is determined as a defective pixel representing the minimum range violation, the image data of the target pixel P22 is compensated by the minimum image data in the adjacent normal pixels stored in the space filter 213 and is outputted the same as the compensated image data. Meanwhile, if the image data of the target pixel P22 has a value of 1.1 times or larger than the maximum value of the adjacent normal pixels and is determined to be a defective pixel representing the maximum range violation, the image data of the target pixel P22 is compensated by the maximum image data in the adjacent normal pixels stored in the space filter 213 and is outputted the same as the compensated image data.

The conditions for evaluating whether or not a pixel is defective may be a function of the characteristics of the image sensor chip. The maximum and minimum range conditions need not necessarily be 1.1 and 0.9.

As previously mentioned, the present invention can detect and compensate defective pixels on a real time basis by using a two-dimension space filter and the characteristics of image data, without an additional non-active memory for storing therein position information of the defective pixels, thereby simplifying test processes for the image sensor and preventing yield of the image sensor chip due to the defective pixel from being degraded.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus, for use with an image sensor having an array of pixels each of which outputs digital image data corresponding to one or more characteristics of light incident thereon, for detecting and compensating for a defective pixel, which comprises:
means for detecting and determining whether a target pixel is defective based on a check condition, the condition being that image data of the target pixel has a value larger than a first coefficient representing a maximum value of image data of adjacent normal pixels or a value smaller than a second coefficient representing a minimum value of image data of adjacent normal pixels; and
means for compensating the image data of a target pixel deemed to be defective and outputting compensated image data, in response to the image data of the target pixel, the maximum value of image data of adjacent normal pixels, the minimum value of image data of the adjacent normal pixels, a defective pixel determination signal representing that the target pixel is defective, and a minimum or maximum range violation signals representing that the image data of the defective pixel violates the maximum or minimum ranges in the check condition, which are provided thereto from the defective pixel detection means.

2. An apparatus according to claim 1, wherein the defective pixel detection means includes:
a first line memory for storing therein the image data fed thereto from the unit pixel on a line-by-line basis;
a second line memory for receiving the image data stored in the first line memory and storing the same therein;
a two-dimension space filter for receiving the image data fed thereto from the second line memory, the image data inputted thereto from the first line memory and the image data provided thereto from the unit pixel, and storing each of the image data in a first set of lines, a second set of lines, and a third set of lines, respectively; and
a defective pixel determination means for receiving the image data provided thereto from the space filter, determining whether or not image data of a target pixel is defective based on the check condition, and outputting a defective pixel determination signal, a minimum range violation signal and a maximum range violation signal according to determined results, wherein the defective pixel determination signal represents that the image data of the target pixel has a value larger than the first coefficient of the maximum value of image data of adjacent normal pixels in the space filter, or a value smaller than the second coefficient of the minimum value of image data of adjacent normal pixels in the space filter, the maximum range violation signal representing that the image data of the target pixel has a value larger than the first coefficient; and the minimum range violation signal representing that the image data of the target pixel has a value smaller than the second coefficient.

3. An apparatus according to claim 2, wherein the defective pixel compensation means includes:
means for combining the minimum range violation signal and the maximum range violation signal provided thereto from the defective pixel detection means;
a first selection means for selectively outputting the minimum image data or the maximum image data in response to output from the combining means; and
a second selection means for selecting one of the output signal from the first selection means and the image data of the target pixel, in response to the defective pixel determination signal from the defective pixel determination means, and outputting the same as the compensated image data;
if the image data of the target pixel has a value larger than the first coefficient of the maximum image data and is determined as the defective pixel, the maximum mage data is outputted as the compensated image data; and
if the image data of the target pixel has a value smaller than the second coefficient of the minimum image data and is determined as the defective pixel, the minimum mage data is outputted as the compensated image data.

4. An apparatus according to claim 3, wherein the first and the second coefficients are selected based on process characteristics of the image sensor.

5. An apparatus according to claim 3, wherein the first and the second coefficients are 1.1 and 0.9, respectively.

6. An apparatus, for use with an image sensor having an array of pixels each of which outputs digital image data corresponding to one or more characteristics of light incident thereon, for detecting and compensating for a defective pixel, which comprises:
a defective pixel detection circuit constructed and arranged to determine whether a target pixel is defective based on a check condition, the condition being that image data of the target pixel has a value larger than a first coefficient representing a maximum value of image data of adjacent normal pixels or a value smaller than a second coefficient representing a minimum value of image data of adjacent normal pixels; and
a compensation circuit constructed and arranged to compensate the image data of a target pixel deemed to be defective and output compensated image data, in response to the image data of the target pixel, the maximum value of image data of adjacent normal pixels, the minimum value of image data of the adjacent normal pixels, a defective pixel determination signal representing that the target pixel is defective, and a minimum or maximum range violation signals representing that the image data of the defective pixel violates the maximum or minimum ranges in the check condition, which are provided thereto from the defective pixel detection circuit.

7. An apparatus according to claim 6, wherein the defective pixel detection circuit includes:
a first line memory for storing therein the image data fed thereto from the unit pixel on a line-by-line basis;
a second line memory for receiving the image data stored in the first line memory and storing the same therein;
a two-dimension space filter for receiving the image data fed thereto from the second line memory, the image data inputted thereto from the first line memory and the image data provided thereto from the unit pixel, and storing each of the image data in a first set of lines, a second set of lines, and a third set of lines, respectively; and
a defective pixel determination circuit constructed and arranged to receive the image data provided thereto from the space filter, determine whether or not image data of a target pixel is defective based on the check condition, and output a defective pixel determination signal, a minimum range violation signal and a maximum range violation signal according to determined results, wherein the defective pixel determination signal represents that the image data of the target pixel has a value larger than the first coefficient of the maximum value of image data of adjacent normal pixels in the space filter, or a value smaller than the second coefficient of the minimum value of image data of adjacent normal pixels in the space filter, the maximum range violation signal representing that the image data of the target pixel has a value larger than the first coefficient; and the minimum range violation signal representing that the image data of the target pixel has a value smaller than the second coefficient.

8. An apparatus according to claim 7, wherein the defective pixel compensation circuit includes:
combining logic constructed and arranged to combine the minimum range violation signal and the maximum range violation signal provided thereto from the defective pixel detection means;
a first selector constructed and arranged to selectively output the minimum image data or the maximum image data in response to output from the combining logic; and
a second selector constructed and arranged to select one of the output signals from the first selector and the image data of the target pixel, in response to the defective pixel determination signal from the defective pixel determination circuit, and output the same as the compensated image data, wherein
if the image data of the target pixel has a value larger than the first coefficient of the maximum image data and is determined as the defective pixel, the maximum mage data is outputted as the compensated image data; and
if the image data of the target pixel has a value smaller than the second coefficient of the minimum image data and is determined as the defective pixel, the minimum mage data is outputted as the compensated image data.

9. An apparatus according to claim 8, wherein the first and the second coefficients are selected based on process characteristics of the image sensor.

10. An apparatus according to claim 8, wherein the first and the second coefficients are 1.1 and 0.9, respectively.
